(19) United States
(12) Patent Application Publication
(10) Pub. No.: US 2021/0105957 A1
(43) Pub. Date: Apr. 15, 2021

(54) AGRICULTURAL EQUIPMENT

(71) Applicant: F & T Spagnolo Pty Ltd., Mildura (AU)

(72) Inventor: Fred Spagnolo, Mildura (AU)

(73) Assignee: F & T Spagnolo Pty Ltd., Mildura (AU)

(21) Appl. No.: 17/047,785

(22) PCT Filed: Apr. 16, 2019
(86) PCT No.: PCT/AU2019/050338

§ 371 Date: Oct. 15, 2020

(30) Foreign Application Priority Data
Apr. 18, 2018 (AU) 2018901291

(51) Int. Cl. A01G 17/02; A01G 3/04

(52) U.S. Cl. CPC A01G 17/023; A01G 3/0408

(57) ABSTRACT

Agricultural equipment for the removal of suckers that shoot from vine, plant or tree trunks. The equipment comprising an elongate, vertically oriented shaft (21) which has a plurality of cord connection points (26) spaced along its length. The cord connection points (26) are operable to releasably connect a flexible cord (27) to the shaft (21) for the purpose of adjusting the height of cords (27) connected to the shaft (21) to suit the height or length of the trunk being treated. A plurality of cords (27) are connected to the shaft (21) to at least some of the cord connection points (26), and a driving arrangement (25) is provided for driving the shaft (21) to rotate about its longitudinal axis.

### PRIORITY CROSS-REFERENCE

The present application claims priority from Australian Provisional Patent Application No. 2018901291 filed 18 Apr. 2018 the contents of which is to be considered to be incorporated into this specification by this reference.

### TECHNICAL FIELD

The present invention relates to agricultural equipment for removing unwanted growth, often called “suckers”, from the stems or trunks of vines, plants or trees. The present invention has been developed in relation to vines grown for wine making purposes in vineyards (grape vines) and it will be convenient to describe the invention in relation to that application. However it is to be appreciated that the application could have wider use in relation to suckers that grow, emerge or shoot from other vines, plants or trees.

### BACKGROUND OF INVENTION

The discussion of the background to the invention that follows is intended to facilitate an understanding of the invention. However, it should be appreciated that the discussion is not an acknowledgement or admission that any aspect of the discussion was part of the common general knowledge as at the priority date of the application.

The trunk of a grape vine extends from ground level and is generally upright. One, or usually two, cordons extend laterally to the trunk and are usually trellised. The useful growth of the vine is from the cordon or cordons and so it is normal practice in vineyards to remove shoots or suckers that grow or emerge from the vine trunk. The removal of these shoots or suckers ensures that the growth in the vine is concentrated in areas of productive grape production, rather than in growth along the trunk, which is of no value. Hereinafter, shoots or suckers will collectively be referred to just as “suckers”.

Suckers that emerge from the trunk of a vine can be manually removed, or chemically or mechanically removed. The present invention relates to mechanical removal of vine suckers and so further commentary will be made in relation to prior art relating to that form of sucker removal.

Some forms of mechanical sucker removal equipment employ a plurality of flexible cords or straps that are rotated or spun at high speed and are brought into engagement with the trunk of a vine as they rotate or spin. It is through the impact of the cords with the vine trunk that any suckers are removed. The equipment can include a shaft or hub from which the cords extend and the shaft or hub is rotated to rotate the cords for engagement with the vine trunk. The equipment can be driven along the row of vines, progressively striping suckers from each vine trunk that the cords engage. The shaft or hub can be oriented vertically so that the cords are generally horizontal as they are spun and engage the vine trunks, but much of the prior art equipment spin cords about a horizontal axis.

The use of rotating or spinning straps is an effective way of removing suckers from vine trunks. The equipment available at present can be driven at a constant speed along or adjacent a row of vines to successively remove vine suckers as the proceeds along the row and engages successive vine trunks. That is, it is not necessary for the equipment to stop or even slow down at each vine trunk for the suckers to be removed. Mechanical removal of vine suckers in this manner is therefore relatively efficient, particularly when compared to removal by hand and does not involve the use of chemicals that is required for chemical sucker removal.

Some prior art forms of sucker removal equipment engage a vine trunk along one side only, so that complete sucker removal from the vine requires a first pass along one side of the trunk and a second pass along the opposite side of the trunk. This makes the removal of suckers more time consuming than with equipment that can treat both sides of a vine trunk in a single pass. In other prior art equipment, a pair of rotatable cord or strap units is provided so that one of the units faces one side of the vine trunk and the other of the units faces the opposite side of the same trunk. With the strap units being driven to rotate, both sides of the vine trunk can be treated in a single pass. This generally halves the time taken for sucker removal but makes the equipment more complex.

A major disadvantage with current equipment is that there is little facility for adjustment to accommodate variations in the height of the vine trunk up to the cordon. That is, the height of the trunk to be treated can vary across different vineyards or plantations. This can occur as a result of the type of vines being grown and the location of the vines. Moreover, there is a need to avoid damaging the trellising and dripping systems employed in vine systems.

Some equipment will not accommodate variations in trunk height because the dimensions of the cord or strap units are fixed. Where that equipment is used to treat vine trunks that have a greater height than the strap unit, there is often the need for a first run with the cord or strap unit at one height to treat a lower section of the vine trunk and then a second run with the cord or strap unit lifted or elevated to treat the remaining and upper section of the vine trunk. The equipment thus needs to be driven along a vine row twice. This obviously doubles the amount of time required for sucker removal and is a drawback in relation to that equipment.

Equipment that employs cords or straps that rotate about a horizontal axis can only accommodate variations in trunk height by extending the length of the cord or strap or by lifting the cord or strap unit as it engages the trunk. However, extending the length of the cords or straps increases the arc through which the cords or straps rotate and thus can cause them to engage the vine leaves or fruit at the top of the trunk as they rotate into engagement with the trunk, and/or they can engage the ground around the trunk. The arc through which the cords or straps rotate cords or straps can also engage the trellis and dripper tubes or lines, potentially damaging the trellis and/or dripper lines by tending to pull on the trellis and/or dripper lines.

Other equipment includes elongate cord or strap units which rotate about a horizontal axis that can be inclined towards vertical in order to increase the trunk height that can be treated. Thus, in that equipment, the minimum height is provided when the cord or strap unit is horizontal and greater height is provided by rotating the cord or strap unit to incline it towards a vertical orientation. While equipment that operates in this manner provides for height adjustment, the equipment has disadvantages such as those discussed above, including that it cannot be used with vines in which elevated dripper lines are installed. This is because the cords or straps will engage the dripper line as well as the vine trunk during operation and engagement of the dripper line at an angle can dislodge it from its mounting or otherwise damage it. Also, the mechanisms for this type of equipment tend to be relatively complex and thus more expensive than non-inclining equipment.

The present invention has therefore been developed keeping in mind the desirability for height adjustability in sucker removal equipment, but without high complexity.

### SUMMARY OF INVENTION

According to the present invention there is provided, equipment for the removal of suckers that shoot from vine, plant or tree trunks, the equipment comprising:
I. an elongate, vertically oriented shaft which has a plurality of cord or strap connection points spaced along its length (hereinafter “cord connection points”), the cord connection points each being operable or arranged to releasably connect a flexible cord or strap (hereinafter “cord”) to the shaft for the purpose of adjusting the height of cords connected to the shaft to suit the height or length of the trunk being treated by the equipment for removal of suckers,
II. a plurality of cords connected to the shaft to at least some of the cord connection points, and
III. a driving arrangement for driving the shaft to rotate about its longitudinal axis.

According to the present invention there is also provided a method of removing suckers from the trunks of vines, plants or trees, the method including using equipment comprising:
I. an elongate, vertically oriented shaft which has a plurality of cord connection points spaced along its length, the cord connection points each being operable or arranged to releasably connect a flexible cord to the shaft for the purpose of adjusting the height of cords connected to the shaft to suit the height or length of the trunk being treated by the equipment for removal of suckers,
II. a plurality of cords connected to the shaft to at least some of the cord connection points, and
III. a driving arrangement for driving the shaft to rotate about its longitudinal axis. the method further including:
IV. measuring the general or average height or length of the trunks being treated for removal of suckers,
V. adjusting the height of cords connected to the shaft to suit the measured general or average height or length,
VI. driving the shaft to rotate about its longitudinal axis and bringing the cords connected to the shaft into contact with the trunks being treated.

The sucker removal equipment and method described above advantageously permits the addition or removal of flexible cords to the shaft so as to vary or adjust the height to which the cords extend along the length of the shaft. This advantageously allows the sucker removal equipment to accommodate changes in the height or length of the vine trunks that are to be treated. That is, a vine trunk that is of a first particular height will require a particular number cords to be attached along the length of the vertical shaft to ensure complete removal of suckers from the trunk. However, for a vine trunk of a second and different height, cords can be added or removed from the shaft depending on whether the second height is greater or lesser than the first height. The use of a vertical shaft is important to provide this advantage.

There is a difference in the present invention between cords of the prior art that can be removed for replacement due to wear or damage and the present invention in which cords are removed or added for the purpose of extending or reducing the height to which the cords are provided along the shaft. Thus, the present invention provides for height adjustability along the length of a shaft of the cords that are provided for sucker removal. This is not provided by prior art arrangements known to the applicant. In those arrangements, cords can be replaced if they are worn or damaged, but it is not easy to do so. The cords are fixed for permanent connection and in fact, the intention of the prior art is that the same number of cords will always be provided regardless of the actual height or length of the vine trunks being treated. There is not facility in the prior art to quickly and easily add or remove cords to customise the height to which the cords are provided along the shaft to suit a particular trunk height being treated. The use of releasably connected flexible cords that are simple and easy to release and replace is important to provide this advantage.

The cord connection points of the present invention are thus operable or arranged to quickly and easily releasably connect a flexible cord or strap to the shaft for the purpose of adjusting the height of cords connected to the shaft to suit the height or length of the trunk being treated by the equipment for removal of suckers.

Advantageously, in the sucker removal equipment and method described above, the shaft can be made to have any suitable length and for example, can be made to have a length that is expected to accommodate from the shortest expected vine trunk, up to the highest or longest expected vine trunk. In the vineyard industry, the variation between the shortest vine trunk to the highest vine trunk is likely to be in the region of about 60 cm. Thus, the shaft can have a length along which cord connection points are provided, that will accommodate the generally shortest expected vine trunk, plus the variation amount mentioned above. For example, the shaft can have a length of about 1.8 m. This of course relates to vines in vineyards and the length of the shaft could be quite different for other types of plants or trees.

In the above manner, vine trunks will be accommodated with the equipment according to the invention across the full expected range of vine trunk lengths. Of course, the length of the shaft will likely be greater than just the length to accommodate the full expected range of vine trunk lengths, because the shaft will additionally include facility for being driven to rotate and for being mounted in a vertical orientation. The cord connection points therefore will be unlikely to extend for the full length of the shaft, but rather for the majority of the shaft length or only a portion of the shaft.

The shaft can also have a length that is short, so that for example, it can be positioned underneath the upper horizontal bar of T-shaped trellising. Where such trellising is used, the vine canopy can spread generally horizontally so that long cord length is required to reach the trunk to be treated if the shaft is positioned outside of the horizontal extent of the canopy. However, the use of a short shaft that can be positioned underneath the canopy means that the shaft can be positioned closer to the trunk and so the cords can be shortened.

For vineyard applications, it is expected that the shaft will always have cords connected sufficient to accommodate the shortest expected vine trunk. These cords will be connected to the shaft at the lower end of the shaft and will often remain permanently connected to the shaft despite being releasably connected. The cords that will generally be removed and connected to the shaft will be those that are in the region higher up the shaft, where variations in the height of the vine trunk are accommodated. However, in respect of those cords that are connected generally permanently to the lower end of the shaft, their releasable connection to the shaft nevertheless provides an advantage in that worn or damaged cords can easily be replaced. Moreover, it is within the scope of the present invention that the cords that are connected to the lower end of the shaft be fixed place in permanent connection to the shaft, i.e. non releasably, so that only the cords that are above the lower cords are releasably connected to the shaft.

The cords can be releasably connected to the shaft in any suitable manner. In one arrangement, the cord connection points of the shaft includes holes, bores or openings (hereinafter “openings”) formed in the shaft with each opening being open at a side wall of the shaft, so that an end of a cord can be inserted into the opening and secured within the opening. The end of the cord can include a fitting that facilitates the end being secured within the opening and for example, the end of the cord can include a threaded fitting to thread into a threaded opening in the shaft. The fitting can be fitted to the end of the cord by any suitable manner, such as by adhesive or by crimping.

The opening can be a blind opening or the opening can extend fully through the shaft so that it opens through two different surfaces of the shaft. In this latter arrangement in which the opening extends fully through the shaft, the opening can be straight or linear so that it opens through diametrically opposite surfaces of the shaft. Where an opening is provided that extends fully through the shaft, the ends of two separate cords can be inserted into the opening and secured therein in order for the two separate cords to extend from opposite sides of the shaft, or, more preferably, a single cord can be extended through the opening to extend on or to either side of the shaft. In this latter arrangement, the cord can be secured within the opening at an approximate mid-point of the cord, so that substantially equal portions or sections of the cord extend on either side of the shaft.

In the arrangement in which a single cord extends through the opening to extend on either side of the shaft, the cord can be secured to the shaft in any suitable manner. Again, the cord can include a fitting at the approximate mid-point of the cord that can be secured to the shaft, against the sides of the shaft for example, or within the opening. The fitting could for example, comprise two mating parts (threaded parts for example) that grip the cord when in mating engagement and that connect to the shaft, such as by clamping against either side of the shaft. The fitting could alternatively comprise clips that clip onto the cord immediately adjacent the exit point of the cord from the opening on either side of the opening, thus preventing the cord from further movement through the opening in either direction.

Alternatively, the cord can be clamped by a different arrangement, for example by a screw, such as a grub screw or bolt, that threads into an opening in the shaft that intersects with the opening through which the cord extends and which engages the cord and clamps it within the opening. This arrangement is simple and effective in securely locating the cord within the opening. Moreover, connection of a cord to the shaft is easy by inserting the cord into and through the opening and then screwing the screw into engagement with the cord. Removal of a cord from the shaft is also easy by unscrewing the screw and thereafter withdrawing the cord from the opening. The screw need not be fully unscrewed from the threaded opening in which it is accommodated, but rather, it can be permanently positioned within that opening and simply screwed inwardly or outwardly for engagement or disengagement with a cord.

In the above arrangement in which a cord is secured within an opening of the shaft by a clamping screw, the opening in which the screw is accommodated can extend at any angle to the opening through which the cord extends, as long as the respective angles intersect. The preference however, is for the opening in which the screw is accommodated to extend at about 90° to the opening through which the cord extends.

It is to be noted that more than one screw could be employed to secure the cord within an opening, so that, for example, a pair of screw openings that intersect with a cord opening could be provided each to accommodate a screw for clamping engagement with the cord.

The openings of the shaft for cord accommodation can have a diameter such that the cords are a relatively loose fit within them, so that the cords are easily fed into and removed from the openings once the securing arrangement used to secure the cords within the openings is removed or released. Alternatively, the openings can taper inwardly, so that as the cord enters the opening the fitting of the cord within the opening becomes tighter. This allows the entry to the openings to be of greater diameter than the cord diameter to facilitate easy insertion of the end of the cord into the opening. The openings might therefore include a tapered section that leads to a constant diameter section and a screw could be used to engage the cord in the constant diameter section. The tapered section might only extend for a short section relative to the length of the constant diameter section. This tapered arrangement might be provided at each end of an opening that extends fully through the shaft so that easy insertion of the end of the cord into the opening is facilitated at either end of the opening. The tapered opening or openings can be a chamfered opening or openings.

It will be evident that many different ways of securing or anchoring a cord within an opening of the shaft exist and that the examples given above are just some of the arrangements that could be used.

It is also within the scope of the present invention that the shaft includes fittings that attach to the shaft and that facilitate connection of cords to the shaft. An example fitting is one that connects to the shaft, such as by welding or brazing, or by clamping or threaded or snap connection, and that includes an opening for accepting a cord. The cord could connect to the opening of the fitting in the same manner as discussed above for cord connection to openings formed in the shaft. In this arrangement, the openings are not provided by the shaft itself, but are provided as part of the shaft. Alternatively, cords could be supplied as part of a device that has a connection for connection to the shaft. Thus, the cords could be formed with a connector attached to the cord, either integrally or by adhesive or other attachment mechanism and the connector that is attached to the cord can be arranged for connection to the shaft. The connector could, for example, include a pin that extends into an opening in the shaft and the pin could be threaded for threaded engagement with the opening, or the pin could be a snap fit into the opening, or could be engaged by a grub screw or bolt for example.

What is important for the invention is that cords be releasably connected to the shaft in any suitable manner so that the height of the plurality of cords that extend from the shaft can be adjusted to suit the vines, plants or trees being treated. Thus, it is the releasable connection of the cords to the shaft that allows the height variation or selection and it is this feature of the invention that permits the invention to provide the flexibility in operation that provides the significant advantages of the invention.

The reference to the shaft being vertically oriented is a reference to the in-use condition of the shaft. That is, in use, the shaft will be oriented vertically rather than at an angle to vertical. Of course, vertical orientation does not require exact 90° to horizontal, but rather, requires a general or substantial vertical orientation, with allowance for deviation from 90° to horizontal to accommodate the uneven terrain that the equipment that embodies the invention will travel over during use of the equipment.

The shaft includes multiple cord connection points so that multiple cords can be made to extend from the shaft along at least a portion of its length. Where the cord connection points are openings of the kind described above, the orientation of the openings can vary so that the cords extend from the shaft in different directions. Other forms of cord connection points can also allow this to occur. Successive openings along the shaft could be oriented at different angles to each other so that one opening could be oriented at 45°, 60° or 90° offset to an immediately adjacent opening. These angles are given as an example only and any suitable angular offset could be employed. In some prototype arrangements, cords that are adjacent longitudinally of the shaft are offset at 60° to each other.

The driving arrangement can take any suitable form and in some forms, it comprises a hydraulic motor coupled to one end of the shaft, preferably an upper end. The shaft can include a keyway or spline, or a square or hexagonal head for coupling to the hydraulic motor. Alternative arrangements include chain or V-belt drive. The hydraulic motor can conveniently be driven from a power pack run from the power take-off (PTO) of a tractor, or the tractor hydraulics. The shaft can be solid or hollow.

The shaft can be mounted to a frame that orients it vertically and that can itself be attached to a vehicle, typically a tractor. Advantageously, the frame can be constructed in a manner that allows it to connect to existing connection arrangements that already exist to connect other equipment to a tractor. For example, the present applicant manufactures other equipment for attachment to a tractor and for that equipment, the present applicant has designed an attachment frame that attaches to the front of a tractor and that includes various mounting and drive arrangements, and hydraulic connectors for mounting and driving that other equipment. The equipment of the present invention can be arranged for connection to that existing attachment frame so that additional mounting equipment is not required.

The frame to which the shaft is mounted can be attached to a vehicle in a manner that allows its position to be adjusted, such as vertically, angularly and/or laterally relative to the vehicle to which it is attached in use.

The frame to which the shaft is mounted can mount a pair of shafts, or even more than a pair of shafts. The provision of a pair of shafts allows the equipment of the invention to treat vine trunks from either side so that the vine suckers can be removed from either side of the trunk in a single pass. Thus, the frame can mount a pair of shafts in spaced apart relationship so that the shafts can be located on either side of a row of vines, with one part of the frame being connected to the vehicle on one side of the row of vines and an opposite side of the frame being located on the opposite side of the row of vines. The frame can include a bridge member to positon the frame parts that support the respective shafts on opposite sides of the row of vines.

The shafts can be mounted so that relative to the direction of travel of the sucker removal equipment along a row of vines, the shafts are in the same plane perpendicular to the direction of travel.

Alternatively, the shafts can be mounted staggered or offset to each other, so that one shaft is ahead of the other in the direction of travel of the sucker removal equipment along a row of vines. In other words, there is a leading and a trailing shaft in the direction of travel or a forward and aft shaft in the direction of travel. This allows the overall width dimension of the frame to be minimised as the working area of the cords of the respective shafts can overlap, but without interfering with each other as a result of the offset. The working area of the cords is the area or space within which cords rotate and in order for suckers to be removed completely from the vine trunk it is usually necessary for the distal ends of the cords to pass or travel through or overlap within the same area or space. But the preference is that the cords do not engage each other during sucker removal, as this might reduce the efficiency of the cords and so the offset described above facilitates this. Minimising the overall width dimension of the frame is important given that there is a finite space between rows of vines within which the frame and tractor needs to fit. The shafts need to be spaced apart sufficiently so that they do not damage the canopy of the vines as they travel past them and the spacing needs to prevent cords from the respective shafts from engaging and fouling each other when the shafts are being rotated. It is the second requirement that tends to dictate the spacing between the shafts and with the shafts in a staggered or offset orientation, the shafts can achieve both of these requirements yet the overall width of the frame is minimised.

The frame can comprise a vertical member that mounts a shaft for rotation. The vertical member can connect to a vehicle such as a tractor. Where two shafts are provided, the frame can comprise a pair of vertical members each of which mounts a shaft for rotation. The vertical members can connect to an upper bridge member and an outer one of the vertical members can be shifted outwardly or inwardly relative to the other of the vertical members to increase or decrease the distance or spacing between the vertical members and thus the distance or spacing of the vertical shafts. An inner one of the vertical members can connect to a vehicle such as a tractor.

The vertical shafts can be mounted to the vertical members by arms that extend from the vertical members. For example, each vertical member can have a pair of vertically spaced apart arms that connect to respective upper and lower ends of the vertical shafts. The vertically spaced apart arms can extend from the vertical members substantially horizontally. The connection between the arms and the shafts can be bearing connections so that the shafts can rotate within the bearings relative to the arms. The driving arrangement can be mounted to the upper arm and connect to the upper end of the vertical shaft. The lower end of the shaft can extend below the lower arm so that the lower arm can, in use, be spaced from the ground. Where the shafts are staggered or offset to each other, this can be achieved by the arms of one of the vertical members extending in the direction of travel of the sucker removal equipment along a row of vines, while the arms of the other of the vertical members extend laterally, preferably perpendicularly to the direction of travel. The arms can however extend in any suitable direction for the offset to be created. While the above discussion relates to a pair of vertical shafts connected to a pair of vertical members, the mounting arrangements discussed can equally apply to a single vertical shaft connected to a single vertical member.

The connection of the vertical shaft to a vertical member by an arm can be a fixed connection whereby the orientation of the shaft is fixed relative to the arm. Alternatively, the connection can be adjustable or variable. While this can be achieved in various ways, in some forms of the invention, an arm can be connected to a vertical member via an adjustable connection that allows the arm to be rotated relative to the member. The arm can be pivotally connected to the vertical member via a bracket and the arm can connect to the bracket at different angles to project from the member at the angle that the operator selects. The bracket can include a plate that has a plurality of openings and the arm can include an opening that can be aligned with one of the plurality of openings so that a pin can be inserted through the aligned openings to locate the arm relative to the bracket in the selected angle relative to the vertical member. Alternatively, the arm can include the plurality of openings and the bracket, or the plate of the bracket can include a single opening. This pin type of adjustment mechanism is simple and effective.

Other adjustment mechanisms could be employed. A meshing geared arrangement could be employed so that a gear associated with the vertical member could mesh with a gear associated with the arm and rotation of one gear shifts the arm angularly relative to the member. This advantageously would provide for finer adjustment and adjustment could be by way of a screw driver or spanner engagement with one of the gears associated with the vertical member or the arm.

More sophisticated adjustment mechanisms could be employed that allow adjustment as the equipment is in motion along a row of vines.

The driving arrangement can comprise a hydraulic motor coupled to an upper end of a shaft as discussed above. Alternatively, the hydraulic motor can be coupled to a lower end of the shaft so that the motor can travel under the canopy of the vines, plants or trees being treated. This arrangement can be attractive where mounting of the motor to an upper end of a shaft will mean that the motor may be dragged though the upper canopy of the vines, plants or trees being treated, causing damage either to the canopy or the motor. In this arrangement, the motor can be supported on the lower arm that supports the vertical shaft, or an alternative support can be provided.

The equipment of the present invention can be used for purposes other than for removing suckers from the stems or trunks of vines, plants or trees. Other unwanted growth can be removed, such as weeds that grow about the base of the trucks of the vines, plants or trees. For this, the shaft can extend close to the ground surface so that cords can extend close to the ground surface. In this form of the invention, the shaft or shafts can be supported on vertical members by arms that extend from the vertical members but the upper arm can be relatively close to the lower arm given that only a short section of shaft is required to mount sufficient cords for weeding purposes. A distance of approximately 300 mm could be sufficient between the upper and lower arms. The motor could be mounted to either arm.

Alternatively, for weeding purposes, the same equipment that is used for sucker removal can be employed, but with cords applied only to the bottom end of the shaft.

A still further form of the invention includes a pair of shafts that are spaced apart to treat the vines, plants or trees on opposite sides of a row, rather than treating just one side of the trunk of a vine, plant or tree with a single shaft, or treating both sides of the trunk of a vine, plant or tree with a pair of shafts. Rather, in this form of the invention, a pair of shafts are spaced apart to bridge between adjacent rows of vines, plants or trees and the cords of each shaft treat one side of the trunk of the respective adjacent rows of vines, plants or trees.

In each of the above forms of the invention, all of the previously described arrangements relating to operation and mounting can be applied, as can the previously described arrangements relating to the releasable connection of cords to the shafts.

### BRIEF DESCRIPTION OF DRAWINGS

In order that the invention may be more fully understood, some embodiments will now be described with reference to the figures in which:

FIG. 1 is a perspective view of agricultural equipment for removing suckers from the stems or trunks of grape vines. according to one embodiment of the invention

FIG. 2 is a front view of the equipment of FIG. 1.

FIG. 3 is a view of a section of a shaft of the agricultural equipment of FIGS. 1 and 2.

FIG. 4 is a plan view of a pivoting arm arrangement according to one embodiment of the invention.

FIG. 5 is an end view of the pivoting arm arrangement of FIG. 4.

FIG. 6 is a side view of the pivoting arm arrangement of FIG. 4.

### DETAILED DESCRIPTION

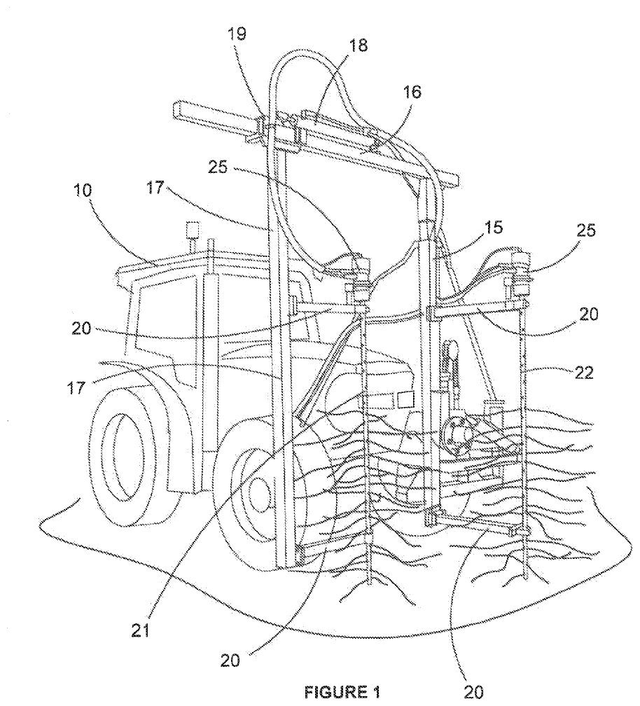

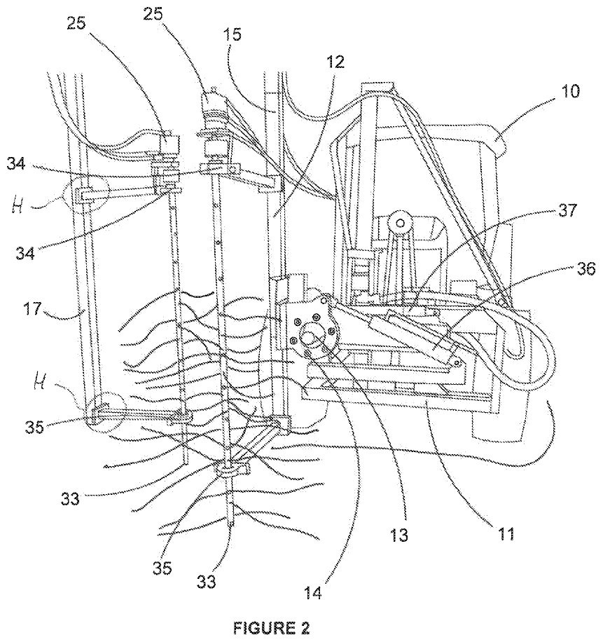

FIGS. 1 and 2 are perspective and front views of vine sucker removal equipment according to one embodiment of the invention. In these figures, a tractor 10 is shown that has an attachment facility 11 attached to the front end of the tractor and to which a frame 12 is attached. The attachment facility 11 includes a stub axle 13 to which is attached a rotatable plate 14, which in turn attaches to a vertical member of the frame 12 that will be referred to herein as an upright 15 of the frame 12. The upright 15 connects to a bridge or cross member 16 of the frame 12 to which a further vertical member or upright 17 of the frame 12 is attached. A hydraulic strut 18 attaches to the cross member 16 and to an upper sliding connector 19 in order to be able to shift the upright 17 relative to the upright 15, i.e. either towards or away from the upright 15, so that the spacing between the respective uprights 15 and 17 can be adjusted. This adjustment is advantageous to enable the operator to customise the spacing of the uprights 15 and 17 to suit the particular vines, plants or trees being treated and advantageously, adjustment can be made easily by hydraulic control of the strut 18, either at the start of the row of vines, plants or trees being treated, or during treatment of the row.

Each of the uprights 15 and 17 includes a pair of horizontal arms 20 that extend perpendicular to their respective uprights to support respective shafts 21 and 22. The arms 20 support the shafts 21 and 22 in a substantially vertical orientation as illustrated.

The arms 20 each include a bearing at the ends remote from their connection with the respective uprights 15 and 17, so that the respective shafts 21 and 22 can be rotated within the bearings. The upper end of each of the shafts 21 and 22 is coupled to a hydraulic motor 25 for driving the shafts 21 and 22 to rotate about their longitudinal axis. The hydraulic motors 25 are connected to the tractor hydraulics or a hydraulic power pack.

It is to be noted that the bottom ends of the shafts 21 and 22 extend to a position below the bottom horizontal arms 20 of each of the uprights 15 and 17. The reason for this is to space the bottom horizontal arms 20 away from the ground during operation of the equipment so the frame 12 does not foul against the ground, but to ensure that the very bottom of a vine trunk can still be engaged by cords that extend from the shafts 21 and 22. It is not as problematic for the ends of the shafts 21 and 22 to engage the ground as that engagement is largely point engagement as compared to the full length of the arms 20.

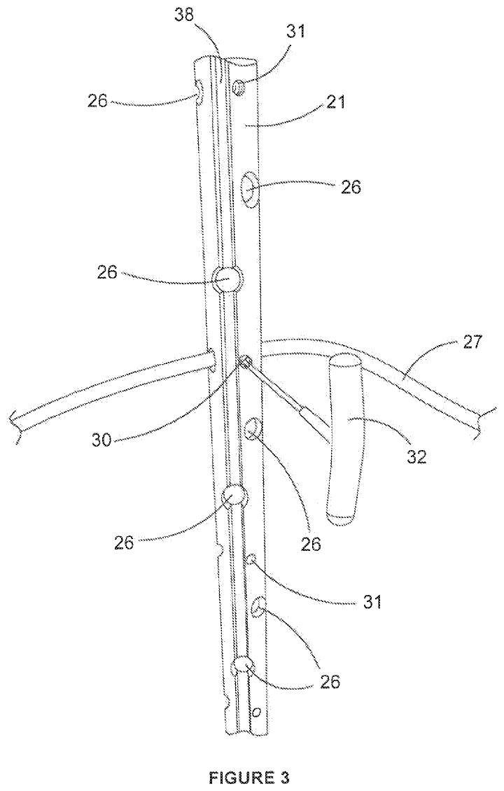

Each of the shafts 21 and 22 include a plurality of releasably connected flexible cords, which, as shown, are spaced along a portion or section of the length or height of the shafts 21 and 22. FIG. 3 illustrates a section of the shaft 21 (although the shafts 21 and 22 are identical) and from this, it can be seen that the shafts 21 and 22 include a series of spaced apart openings 26, each of which is available for receipt of a cord 27. In FIG. 3, a single cord 27 is illustrated, but as can be seen from FIGS. 1 and 2, approximately 18 cords are attached to each of the shafts 21 and 22, commencing from the bottom end of those shafts.

The cord 27 is a relatively loose fit within the opening 26 with which it is associated. This allows the cord 27 to be easily inserted into the opening 26 and removed from that opening. The openings 26 extend fully through the shaft 21 so that the openings 26 open through diametrically opposed sides of the shaft. The entry to each side of the opening is chamfered or countersunk to facilitate easy insertion of the cord 27 into the opening 26.

Successive openings are offset from each other by 60°. This means that the cords which are inserted into openings 26 directly above and below the cord 27 illustrated in FIG. 3, will extend from the shaft at 60° to the cord 27. This angular offset arrangement is illustrated in FIGS. 1 and 2.

The cord 27 is secured within the opening 26 by a grub screw 30 or a bolt or the like. The grub screw 30 screws into a threaded opening which is oriented at 90° to the opening 26 with which it is associated. Further threaded grub screw openings 31 are seen in FIG. 3. Each grub screw opening 31 intersects with an associated opening 26, so that a grub screw 30 which is threaded into an opening 31 can be threaded to a depth into that opening to a position at which the leading end of the grub screw 30 engages the cord 27. By that engagement, the grub screw 30 clamps the cord 27 in place within the opening 26. FIG. 3 illustrates a hand driven driver 32 that can be used to thread the grub screw 30 into or out of the opening 31. Of course an electric driver could alternatively be used.

Also seen in FIG. 3 is that the shaft 21 is a solid shaft and includes a lengthwise keyway 38 for mating with the driving arrangement for driving the shaft to rotate. In the illustrated arrangement, the driving arrangement includes the hydraulic motors 25. The mating connection of the shaft 21 with a hydraulic motor 25 can be such as to support the shaft 21 in the position shown so that the bearings 34 and 35 are only required to support the shaft 21 for rotation.

Returning to FIGS. 1 and 2, it can be seen from these figures that the shafts 21 and 22 each include openings 26 for the full length of the shaft between the bottom ends 33 and the upper bearings 34. However, the cords 27 are only included up to about a half way point between the lower bearings 35 and the upper bearings 34. This illustrates that cords 27 can be connected to the shaft to the height required to suit the height of the particular vine trunks being treated. Where the vine trunks are shorter, upper cords 27 can be removed from the shafts 21 and 22. Conversely, where the vine trunks are longer of higher, cords 27 can be added to the shafts 21 and 22. Where there are no suckers to be removed at the very bottom of the vine trunks, the cords 27 at the bottom of the shafts 21 and 22 can be removed. Where the equipment is used for weeding purposes, only cords below the bottom bearing 35 need to be attached.

The addition and removal of cords is very easy, and involves simply unthreading the grub screw 30 to a position in which the cord 27 can either be inserted into the opening 26 or removed from that opening and if a cord 27 is being inserted in the opening 26, once it is properly positioned in that opening, most likely with an approximately equal length on either side of the opening 26, the grub screw 30 can be retightened against the cord 27 to lock, secure or clamp it in position within the opening 26.

The present invention is therefore characterised by the ability to add or remove cords to/from a rotatable shaft in order to increase or decrease the height of the cords that will treat trunks, such as vine trunks. The ability to easily add or remove cords in the manner described above is not a functional characteristic of other vine sucker removal equipment of which the applicant is aware. While that prior art equipment provides for replacement of damaged or worn cords, the intention in that equipment is that the same length or breadth of cord is maintained at all times regardless of the height of the vine trunks being treated. This means that in some equipment, the more than two passes along a row of vines is required to treat the entire height of the vine trunks.

It will be evident from the figures of the simple nature of the equipment of the invention. While FIG. 2 shows that the frame 12 can be tilted or angularly rotated by hydraulic strut 36 rotating the plate 14 about the stub axle 13, the hydraulic strut 37 can shift the entire frame 12 laterally either outwardly or inwardly. Moreover, as explained before, the hydraulic strut 18 (FIG. 1) can shift the upright 17 relative to the upright 15 to adjust the spacing between the uprights 15 and 17. Otherwise, the arrangement disclosed in the figures is very simple and utilises the existing hydraulics of the tractor 10 to drive the hydraulic motors 25 and the various hydraulic struts.

It will be further evident particularly from FIG. 1, that the arms 20 that extend from the upright 15, extend in the direction of travel of the tractor 10 along a row of vines, whereas the arms 20 that extend from the upright 17 extend perpendicular to the direction of travel. This allows the shaft 21 to be offset in the direction of travel relative to the shaft 22. This allows the shafts 21 and 22 to be positioned closer to each other in terms of spacing perpendicular to the direction of travel. This reduces the overall width of the frame 12 and so allows more room for the tractor 10 and the frame 12 to travel between rows of vines.

The arms 20 could alternatively extend in the same direction either in the direction of travel of the tractor 10 along a row of vines, or perpendicular to the direction of travel. Moreover, as described above, only a single shaft 21 could be provided so that the cross member 16 and the upright 17 can be removed.

In a further alternative, the arrangement of the figures can be modified so that instead of the cross member 16 bridging over the top of a vine so that the cords of the shafts 21 and 22 engage opposite sides of the vine trunk, the respective shafts 21 and 22 can be spaced apart to opposite sides of the tractor 10 so that the cords of the shafts 21 and 22 engage different trunks of adjacent rows of vines.

In still further alternatives, the arms 20 can be hinged at the section circled H in FIG. 2, so that the arms 20 can be positioned other than in the direction of travel of the tractor 10, or perpendicular to the direction of travel. Both pairs of arms 20 of both of the upright members 15 and 17 can be hinged, or just one of the pairs of arms can be hinged. The hinged arrangement can take any suitable form.

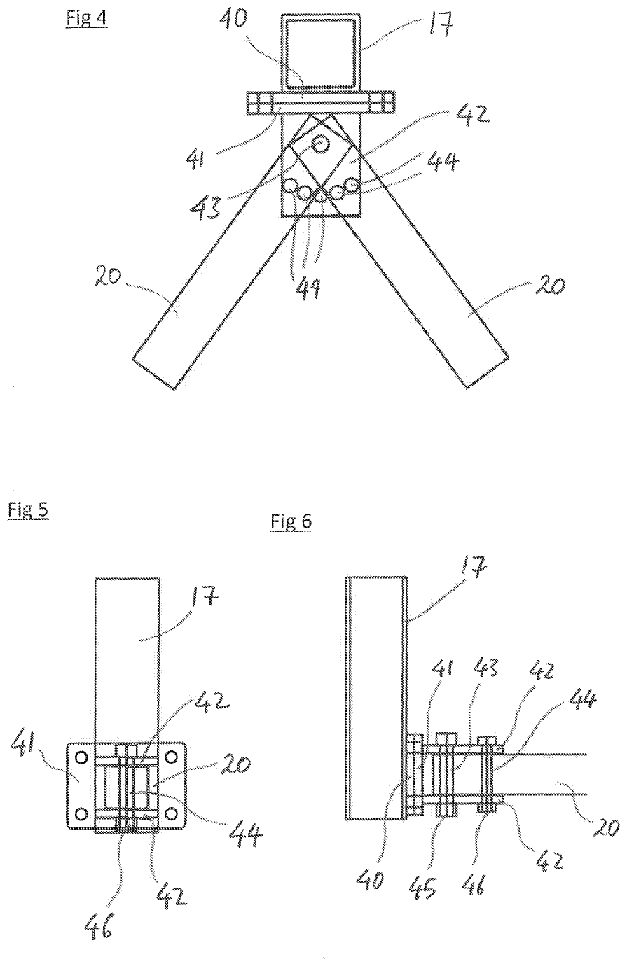

FIGS. 4 to 6 show plan, front and side views of a pivoting arm arrangement according to one embodiment of the invention. These figures show the upright 17 and in FIG. 4, two arms 20 are shown in angularly spaced potions. It will be appreciated that in practice only one are is provided (as shown in the earlier figures), but two arms 20 are shown in FIG. 4 to illustrate the different angular positions of the arm 20 that can be achieved in this aspect of the present invention.

Welded to the upright 17 is a plate 40. Bolted to the plate 40 is another plate 41. Welded to the plate 41 are two spaced apart, parallel plates 42. The arm 20 is positioned between the plates 41 and 42 and is secured by pins 43 and 44. Pin 43 is a permanent pivot pin that is secured in place with a nut 45 and about which the arm 20 can pivot or rotate. Pin 44 is a locking pin which is also secured by a nut 46. Removal of the nut 46 allows the pin 44 to be withdrawn and for the arm 20 to be rotated about the pin 43 to anyone of the five positions shown in FIG. 4. Reinstalment of the pin 44 and application of the nut 46 locks the arm 20 in the selected angular orientation. By this arrangement, the angular orientation of the arm 20 can be adjusted.

It will be clear that the arrangement shown in FIGS. 4 to 6 is just one example arrangement that allows angular adjustment of the arm 20 so that various other arrangements are within the scope of the present invention.

Where any or all of the terms “comprise”, “comprises”, “comprised” or “comprising” are used in this specification (including the claims) they are to be interpreted as specifying the presence of the stated features, integers, steps or components, but not precluding the presence of one or more other features, integers, steps or components.

Those skilled in the art will appreciate that the invention described herein is susceptible to variations and modifications other than those specifically described. It is understood that the invention includes all such variations and modifications which fall within the spirit and scope of the present invention.

1. Agricultural equipment for the removal of suckers that shoot from vine, plant or tree trunks, the equipment comprising:
I. an elongate, vertically oriented shaft which has a plurality of cord connection points spaced along its length, the cord connection points each being operable to releasably connect a flexible cord to the shaft for the purpose of adjusting the height of cords connected to the shaft to suit the height or length of the trunk being treated by the equipment for removal of suckers,
II. a plurality of cords connected to the shaft to at least some of the cord connection points, and
III. a driving arrangement for driving the shaft to rotate about its longitudinal axis.

2. Agricultural equipment according to claim 1, the cord connection points of the shaft comprise openings with each opening being open at a side wall of the shaft, so that an end of a cord can be inserted into the opening and secured within the opening.

3. Agricultural equipment according to claim 2, opening extending fully through the shaft so that it opens through two different surfaces of the shaft.

4. Agricultural equipment according to claim 3, the opening being straight or linear so that it opens through diametrically opposite surfaces of the shaft.

5. Agricultural equipment according to claim 3, the cords that are connected to the shaft extending through the opening to extend on either side of the shaft.

6. Agricultural equipment according to claim 5, the cords that are connected to the shaft being secured within the opening at an approximate mid-point of the cord, so that substantially equal portions or sections of the cord extend on either side of the shaft.

7. Agricultural equipment according to claim 6, the cords that are connected to the shaft being secured within the opening by a screw that threads into an opening in the shaft that intersects with the opening through which the cord extends and which engages the cord and clamps it within the opening.

8. Agricultural equipment according to claim 7, the opening in which the screw threads into extends at about 90° to the opening through which the cord extends.

9. Agricultural equipment according to claim 2, the openings of the shaft through which cords extend having a diameter such that the cords are a relatively loose fit within them, so that the cords are easily fed into and removed from the openings once the securing arrangement used to secure the cords within the openings is removed or released.

10. Agricultural equipment according to claim 2, the openings of the shaft through which cords extend being oriented at different angles to each other so that the cords of different openings extend from the shaft in different directions.

11. Agricultural equipment according to claim 10, successive openings along the shaft being oriented at 45°, 60° or 90° offset to an immediately adjacent opening.

12-13. (canceled)

14. Agricultural equipment according to claim 1, the equipment comprising
I. a pair of elongate, vertically oriented shafts which have a plurality of cord connection points spaced along their length, the pair of shafts being spaced apart for positioning on either side of a row of vine, plant or tree trunks,
II. a plurality of cords connected to each of the shafts to at least some of the cord connection points, and
III. a driving arrangement for driving each of the shafts to rotate about their longitudinal axis.

15. Agricultural equipment according to claim 14, the pair of shafts being offset in the direction of travel of the equipment along a row of vine, plant or tree trunks.

16. (canceled)

17. Agricultural equipment according to claim 14, the pair of shafts being mounted to a frame comprising a pair of vertical members each of which mounts a shaft for rotation, the vertical members being connected to an upper bridge member.

18. Agricultural equipment according to claim 17, and an outer one of the vertical members being shiftable outwardly or inwardly relative to the other of the vertical members to increase or decrease the distance or spacing between the vertical members and thus the vertical shafts.

19. Agricultural equipment according to claim 16, the shafts being mounted to the vertical members by arms that extend from the vertical members, each vertical member having a pair of vertically spaced apart arms that connect to respective upper and lower ends of the vertical shafts.

20. (canceled)

21. Agricultural equipment according to claim 19, the lower end of each shaft extending below the lower arm so that the lower arm can, in use, be spaced from the ground.

22. A method of removing suckers from the trunks of vines, plants or trees, the method including using equipment according to claim 1, the method comprising:
I. measuring the general or average height or length of the trunks being treated for removal of suckers,
II. adjusting the height of cords connected to the shaft to suit the measured general or average height or length,
III. driving the shaft to rotate about its longitudinal axis and bringing the cords connected to the shaft into contact with the trunks being treated.

23. A method of removing suckers from the trunks of vines, plants or trees, the method including using equipment according to claim 14, the method comprising:
I. measuring the general or average height or length of the trunks being treated for removal of suckers,
II. adjusting the height of cords connected to the shafts to suit the measured general or average height or length,
III. driving the shafts to rotate about their longitudinal axis and bringing the cords connected to the shafts into contact with the trunks being treated on either side of the trunks.

24. A method of removing suckers from the trunks of vines, plants or trees, the method including using equipment comprising:
I. an elongate, vertically oriented shaft which has a plurality of cord connection points spaced along its length, the cord connection points each being operable to releasably connect a flexible cord to the shaft for the purpose of adjusting the height of cords connected to the shaft to suit the height or length of the trunk being treated by the equipment for removal of suckers,
II. a plurality of cords connected to the shaft to at least some of the cord connection points, and
III. a driving arrangement for driving the shaft to rotate about its longitudinal axis. the method further including:
IV. measuring the general or average height or length of the trunks being treated for removal of suckers,
V. adjusting the height of cords connected to the shaft to suit the measured general or average height or length,
VI. driving the shaft to rotate about its longitudinal axis and bringing the cords connected to the shaft into contact with the trunks being treated.

25. (canceled)
